(19) United States
(12) Patent Application Publication
(10) Pub. No.: US 2009/0288499 A1
(43) Pub. Date: Nov. 26, 2009

(54) Torque measurement device and program

(76) Inventor: Shuichi Umezawa, Tokyo (JP)

Correspondence Address: Muramatsu & Associates, 114 Pacifica, Suite 225, Irvine, CA, 92618, US

(21) Appl. No.: 12/309,278

(22) PCT Filed: Jul. 13, 2006
(86) PCT No.: PCT/JP2006/313943

§ 371 Date: Jan. 12, 2009

(51) Int. Cl. G01L 3/00

(52) U.S. Cl. 73/862.324

(57) ABSTRACT

[Problems] To provide a torque measurement device capable of more accurately specifying positions of reflectors which are attached to a rotating body, and more accurately obtaining a torque of the rotating body.

S [Means for Solving Problems] A signal processing device (16) irradiates the surface of the rotating body (13) with laser light from a laser light output device (11) via a light transmitting/receiving device (12), and obtains the torque of the rotating body (13) by using a reflection patterns from reflectors (14a, 14b) provided on the surface of the rotating body (13). The signal processing device (16) stores reflected light data of the laser light which irradiates the surface of the rotating body (13), the reflected light data being input according to rotation of the rotating body, specifies a position having the reflected light data, which matches each of reference reflection patterns of the pair of reflectors (14a, 14b), to be the reflector position from the reflected light data of the rotating body (13), the pair of reflectors (14a, 14b) being provided on the surface of the rotating body (13) and having a spacing in the axial direction, calculates a twist amount of the rotating body (13) from the specified positions of the pair of reflectors, and calculates the torque from the calculated twist amount of the rotating body (13).

### TECHNICAL FIELD

The present invention relates to a torque measurement device and a torque measurement program, which measure a rotating speed and an axial torque of a rotating body optically in a non-contact mode.

### BACKGROUND ART

There has been developed an optical torque measurement device for detecting a torque of a drive axis (rotating body) in a rotating equipment such as a gas turbine and a steam turbine, for the purpose of identifying a cause of change in a thermal efficiency of a combined-cycle generating plant or a steam turbine plant, for example. This torque measurement device provides a pair of reflectors at different positions on the rotating body in the axial direction thereof, irradiates both of the reflectors with laser light and detects reflected light thereof from both of the reflectors, obtains a rotation period of the rotating body from periodical strong and weak intensities of the reflected light, and detects a torque of the rotating body from a delay time of the reflected light between the reflectors (refer to Patent document 1, for example).

In such a torque measurement device, extraction of the reflected light data necessary for signal processing, yes-no judgment of a processed result in the signal processing, or the like, is operated manually by an analyzer and takes a long time for the analysis job thereof. Accordingly, there is a technique that specifies a reflection pattern position of the reflected light reflected by the reflector which is provided to the rotating body, automatically using a signal processing device, calculates the rotation period or a twist amount of the rotating body from data within a reflection pattern range determined by the specified reflection pattern position, automatically using the signal processing device, and calculates the torque from the calculated twist amount of the rotating body (refer to Patent document 2, for example).

Patent document 1: Japanese Unexamined Patent Application Publication No. 2002-22564
Patent document 2: Japanese Unexamined Patent Application Publication No. 2005-16950

### DISCLOSURE OF THE INVENTION

### Problems to be Solved by the Invention

However, when the analyzer manually extracts the reflected light data of the reflectors, which is necessary for the signal processing, the analysis job takes a long time and also the extraction of the reflected light becomes inaccurate, if the reflected light data contains noise.

Further, the technique of Patent document 2 reads the reflected light data of the reflectors on the rotating body, generates a trigger value based on the maximum and minimum values of the read reflected light data, and determines a region having a value exceeding the trigger value to be a reflection pattern region of the reflector. Although the technique can specify the position of the reflector automatically, since calculating the trigger value by multiplying a difference between the maximum and minimum values by a certain ratio, the technique sometimes cannot accurately specify the position of the reflector depending on how to determine the ratio. If the position of the reflector is not accurate, the torque calculated therefrom also has an error.

An object of the present invention is to provide a torque measurement device and a torque measurement program which can more accurately specify the positions of the reflectors attached to the rotating body and can more accurately obtain the torque of the rotating body.

### Means for Solving the Problems

The torque measurement device according to a first aspect of the invention is provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof, and reflects the irradiating laser light from the light transmitting/receiving device in a reflection pattern, and a signal processing device obtaining a torque of the rotating body from the reflected light received by the light transmitting/receiving device, wherein the signal processing device includes: a reference reflection-pattern storage section preliminarily storing a reference reflection pattern of the reflected light obtained by reflection from the pair of reflectors; an input data storage section storing reflected light data of the laser light irradiating the surface of the rotating body, the reflected light data being input according to rotation of the rotating body; a reflector position specification unit specifying a position having the reflected light data, which matches the reference reflection pattern stored in the reference reflection-pattern storage section, to be a reflector position from the reflected light data of the rotating body, the reflected light data being stored in the input data storage section; a twist amount calculation unit calculating a twist amount of the rotating body from the reflector positions which are specified by the reflector position specification unit; and a torque calculation unit calculating a torque from a twist amount of the rotating body, the twist amount being calculated by the twist amount calculation unit.

The torque measurement device according to a second aspect of the invention is provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof, and reflects the irradiating laser light from the light transmitting/receiving device in a predetermined reflection pattern, and a signal processing device obtaining a torque of the rotating body from the reflected light received by the light transmitting/receiving device, wherein the signal processing device includes: a reference reflection-pattern storage section preliminarily storing a reference reflection pattern of the reflected light obtained by reflection from the pair of reflectors; an input data storage section storing reflected light data of the laser light irradiating the surface of the rotating body, the reflected light data being input according to rotation of the rotating body; an approximate reflector-position detection unit detecting approximate positions of the pair of reflectors from the reflected light data of the rotating body, the reflected light data being stored in the input data storage section; a reflector position specification unit specifying a position having the reflected light data, which matches the reference reflection pattern stored in the reference reflection-pattern storage section, to be a reflector position from the reflection light data in neighborhoods of the approximate positions of the pair of reflectors, the reflected light data being detected by the approximate reflector-position detection unit; a twist amount calculation unit calculating a twist amount of the rotating body from the reflector positions which are specified by the reflector position specification unit; and a torque calculation unit calculating a torque from a twist amount of the rotating body, the twist amount being calculated by the twist amount calculation unit.

The torque measurement device according to a third aspect of the invention is provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof, and reflects the irradiating laser light from the light transmitting/receiving device in a predetermined reflection pattern, and a signal processing device obtaining a torque of the rotating body from the reflected light received by the light transmitting/receiving device, wherein the signal processing device includes: a reference reflection-pattern storage section preliminarily storing a reference reflection pattern of the reflected light obtained by reflection from the pair of reflectors; an input data storage section storing reflected light data of the laser light irradiating the surface of the rotating body, the reflected light data being input according to rotation of the rotating body; a reflector existence-region detection unit detecting existence regions of the pair of reflectors by determining a point which minimizes AIC of a model for the reflected light data of the rotating body, the reflected light data being stored in the input data storage section; a reflector position specification unit specifying a position having the reflected light data, which matches the reference reflection pattern stored in the reference reflection-pattern storage section, to be a reflector position from the reflected light data of the existence regions of the pair of reflectors, the existence regions being detected by the reflector existence-region detection unit; a twist amount calculation unit calculating a twist amount of the rotating body from the reflector positions which are specified by the reflector position specification unit; and a torque calculation unit calculating a torque from a twist amount of the rotating body, the twist amount being calculated by the twist amount calculation unit.

The torque measurement device according to a fourth aspect of the invention is provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof, and reflects the irradiating laser light from the light transmitting/receiving device in a predetermined reflection pattern, and a signal processing device obtaining a torque of the rotating body from the reflected light received by the light transmitting/receiving device, wherein the signal processing device includes: a reference reflection-pattern storage section preliminarily storing a reference reflection pattern of the reflected light obtained by reflection from the pair of reflectors; an input data storage section storing reflected light data of the laser light irradiating the surface of the rotating body, the reflected light data being input according to rotation of the rotating body; an approximate reflector-position detection unit detecting approximate positions of the pair of reflectors from the reflected light data of the rotating body, the reflected light data being stored in the input data storage section;

a reflector existence-region detection unit detecting existence regions of the pair of reflectors by determining a point which minimizes AIC of a model for the reflected light data in neighborhoods of the approximate reflector positions of the pair of reflectors, the approximate reflector position being detected by the approximate reflector-position detection unit; a reflector position specification unit specifying a position having the reflected light data, which matches the reference reflection pattern stored in the reference reflection-pattern storage section, to be a reflector position from the reflected light data of the existence regions of the pair of reflectors, the existence regions being detected by the reflector existence-region detection unit; a twist amount calculation unit calculating a twist amount of the rotating body from the reflector positions which are specified by the reflector position specification unit; and a torque calculation unit calculating a torque from a twist amount of the rotating body, the twist amount being calculated by the twist amount calculation unit.

The program according to a fifth aspect of the invention enables a computer to carry out a method including the steps of: storing reflected light data of laser light irradiating a surface of a rotating body, the reflected light data being input according to rotation of the rotating body; specifying a position having the reflected light data, which matches each of reference reflection patterns of a pair of reflectors, to be a reflector position from the reflected light data of the rotating body, the pair of reflectors being provided on the surface of the rotating body and having a spacing in an axial direction thereof; calculating a twist amount of the rotating body from the specified positions of the pair of reflectors; and calculating a torque from the calculated twist amount of the rotating body.

The program according to a sixth aspect of the invention enables a computer to carry out a method including the steps of: storing reflected light data of laser light irradiating a surface of a rotating body, the reflected light data being input according to rotation of the rotating body; detecting approximate positions of the pair of reflectors from the reflected light data of the rotating body; specifying a position having the reflected light data, which matches each of reference reflection patterns of a pair of reflectors, to be a reflector position from the reflected light data in neighborhoods of the detected approximate positions of the pair of reflectors, the pair of reflectors being provided on the surface of the rotating body and having a spacing in an axial direction thereof; calculating a twist amount of the rotating body from the specified reflector positions; and calculating a torque from the calculated twist amount of the rotating body.

The program according to a seventh aspect of the invention enables a computer to carry out a method including the steps of: storing reflected light data of laser light irradiating a surface of a rotating body, the reflected light data being input according to rotation of the rotating body; detecting existence regions of the pair of reflectors by determining a point which minimizing AIC of a model for the reflected light data of the rotating body; specifying a position having the reflected light data, which matches each of reference reflection patterns of a pair of reflectors, to be a reflector position from the reflected light data of the detected existence regions of the pair of reflectors, the pair of reflectors being provided on the surface of the rotating body and having a spacing in an axial direction thereof; calculating a twist amount of the rotating body from the specified reflector positions; and calculating a torque from the calculated twist amount of the rotating body.

The program according to a eighth aspect of the invention enables a computer to carry out a method including the steps of: storing reflected light data of laser light irradiating a surface of a rotating body, the reflected light data being input according to rotation of the rotating body; detecting approximate positions of the pair of reflectors from the reflected light data of the rotating body; detecting existence regions of the pair of reflectors by determining a point which minimizing AIC of a model for the reflected light data in neighborhoods of the detected approximate positions of the pair of reflectors; specifying a position having the reflected light data, which matches each of reference reflection patterns of a pair of reflectors, to be a reflector position from the reflected light data of the detected existence regions of the pair of reflectors, the pair of reflectors being provided on the surface of the rotating body and having a spacing in an axial direction thereof; calculating a twist amount of the rotating body from the specified reflector positions; and calculating a torque from the calculated twist amount of the rotating body.

### ADVANTAGES OF THE INVENTION

The present invention preliminarily prepares the reference reflection pattern of the reflected light obtained by reflection from the pair of reflectors which is provided on the surface of the rotating body having the spacing in the axial direction, specifies the reflector positions by extracting the reflected light pattern, which matches the reference reflection pattern, from the reflected light data input according to the rotation of the rotating body, and thereby can detect the reflector positions accurately. Accordingly, it becomes possible accurately to measure the torque calculated for the reflector positions.

Further, the present invention detects the approximate positions of the pair of reflectors or the existence region of the pair of reflectors from the reflected light data of the rotating body, and then extracts the reflection pattern matching the reference reflection pattern from the reflected light data in the neighborhoods of the approximate positions of the pair of reflectors or the existence region of the pair of reflectors. Thereby, it is possible to detect the reflector positions quickly and also accurately.

Moreover, the present invention detects the approximate positions of the pair of reflectors from the reflected light data of the rotating body, further detects the existence regions of the pair of reflectors from the reflected light data in the neighborhoods of the approximate positions, and extracts the reflected light pattern matching the reference reflection pattern from the reflected light data in the existence regions of the pair of reflectors. Thereby, it is possible to detect the reflector positions more quickly and also more accurately.

### BRIEF DESCRIPTION OF THE DRAWINGS

FIG. 1 is a block configuration diagram of a torque measurement device according to a first embodiment of the present invention.

FIG. 2 is a plan view of a reflector in the first embodiment of the present invention.

FIG. 3 is a signal waveform chart normalized from a measured waveform value which is obtained from reflected light data of a reflector after a trend component is removed, in the first embodiment of the present invention.

FIG. 4 is an explanatory diagram of reflected light data obtained from a pair of reflectors in the first embodiment of the present invention.

FIG. 5 is a flowchart showing a torque measurement method measuring a torque using the torque measurement device according to the first embodiment of the present invention.

FIG. 6 is a block configuration diagram of a torque measurement device according to a second embodiment of the present invention.

FIG. 7 is an explanatory diagram of range average processing in an approximate reflector-position detection unit of the second embodiment of the present invention.

FIG. 8 is an explanatory diagram of approximate reflector-position detection processing in the approximate reflector-position detection unit in the second embodiment of the present invention.

FIG. 9 is a flowchart of a torque measurement method measuring a torque using the torque measurement device according to the second embodiment of the present invention.

FIG. 10 is a block configuration diagram of a torque measurement device according to a third embodiment of the present invention.

FIG. 11 is an explanatory diagram of a calculation range of AICp for a reflected light data model in the third embodiment of the present invention.

FIG. 12 is an explanatory diagram of an AICp calculation result for the reflected light data model in the third embodiment of the present invention.

FIG. 13 is a flowchart showing a torque measurement method measuring a torque using the torque measurement device according to the third embodiment of the present invention.

FIG. 14 is a block configuration diagram of a torque measurement device according to a fourth embodiment of the present invention.

FIG. 15 is a flowchart showing a torque measurement method measuring a torque using the torque measurement device according to the fourth embodiment of the present invention.

### DESCRIPTION OF THE SYMBOLS

11: Laser light output device, 12: Light transmitting/receiving device, 13: Rotating body, 14: Reflector, 15: Light detection device, 16: Signal processing device, 17: Signal input processing unit, 18: Input data storage section, 19: Reference reflection-pattern storage section, 20: Reflector position specification unit, 21: Twist amount calculation unit, 22: Torque calculation unit, 23: Output processing unit, 24: Output device, 25: Reflection portion, 26: Absorption portion, 27: Approximate reflector-position detection unit, 28: Reflector existence-region detection unit

### BEST MODES FOR CARRYING OUT THE INVENTION

### First Embodiment

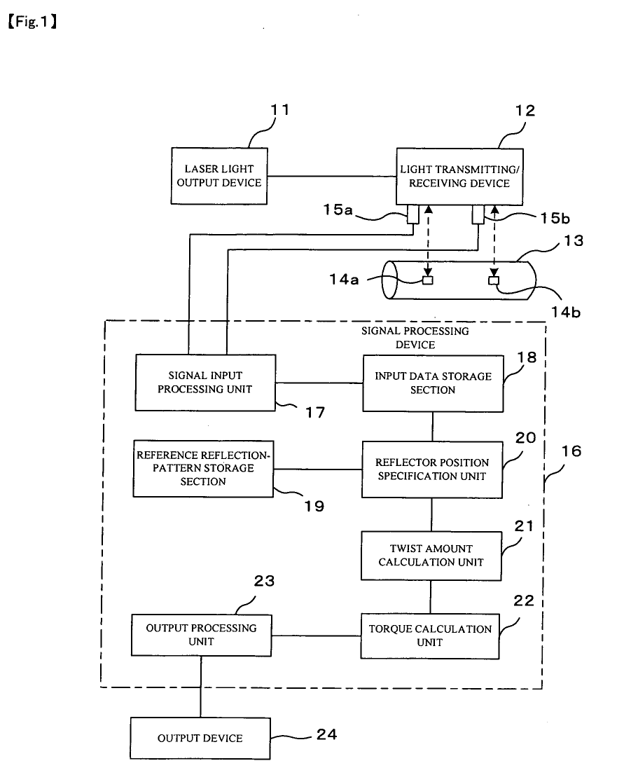

FIG. 1 is a block configuration diagram of a torque measurement device according to a first embodiment of the present invention. Laser light output from a laser light output device 11 irradiates the surface of a rotating body 13 via a light transmitting/receiving device 12. A pair of reflectors 14a and 14b is provided on the surface of the rotating body 13, having a spacing in the axial direction, and reflects the irradiating laser light from the light transmitting/receiving device 12 in a predetermined reflection pattern. Each of the reflectors 14a and 14b has a reflection pattern which is formed in a bar-code pattern with a portion reflecting the laser light and a portion absorbing the laser light, for example, and generates reflected light according to the reflection pattern when irradiated by the laser light. The reflected light reflected on the surface of the rotating body 13 including the reflectors 14a and 14b is received by the light transmitting/receiving device 12, and reflection intensity thereof is detected by light detection devices 15a and 15b and input into a signal input processing unit 17 of a signal processing device 16. In the following description, there will be described a case in which one set of the pair of reflectors 14a and 14b is provided around the rotating body 13.

The signal processing device 16 obtains a rotation period and a twist amount of the rotating body 13 using the reflected light reflected by the pair of reflectors 14a and 14b within the reflected light reflected by the surface of the rotating body 13, and further obtains a torque. The signal input processing unit 17 of the signal processing device 16 carries out filtering processing, for example, of the input reflected light data of the rotating body 13 and stores the reflected light data in each rotation of the rotating body 13 into an input data storage section 18 for a predetermined number of rotations.

Meanwhile, a reference reflection-pattern storage section 19 preliminarily stores reference reflection patterns of the reflected light data obtained by the reflection of the pair of reflectors 14a and 14b. A reflector position specification unit 20 inputs the reflected light data of the rotating body 13 stored in the input data storage section 18, sequentially in a time series, carries out pattern matching comparing the reflected light data with the reference reflection pattern stored in the reference reflection-pattern storage section 19, and specifies a reflector position having the matching reflected light data in real time.

The positions of the pair of reflectors 14a and 14b, which are specified by the reflector position specification unit 20, are input into a twist amount calculation unit 21. The twist amount calculation unit 21 calculates a twist amount of the rotating body 13 from the positions of the pair of reflectors 14a and 14b. The twist amount of the rotating body 13, which is calculated by the twist amount calculation unit 21, is input into a torque calculation unit 22, and the torque calculation unit 22 calculates a torque of the rotating body 13 from the twist amount of the rotating body, which is calculated by the twist amount calculation unit 21. The torque of the rotating body 13, which is calculated by the torque calculation unit 22, is provided with output processing by an output processing unit 23 and output to outside from the signal processing device 16. FIG. 1 shows a case of outputting to an output device 24.

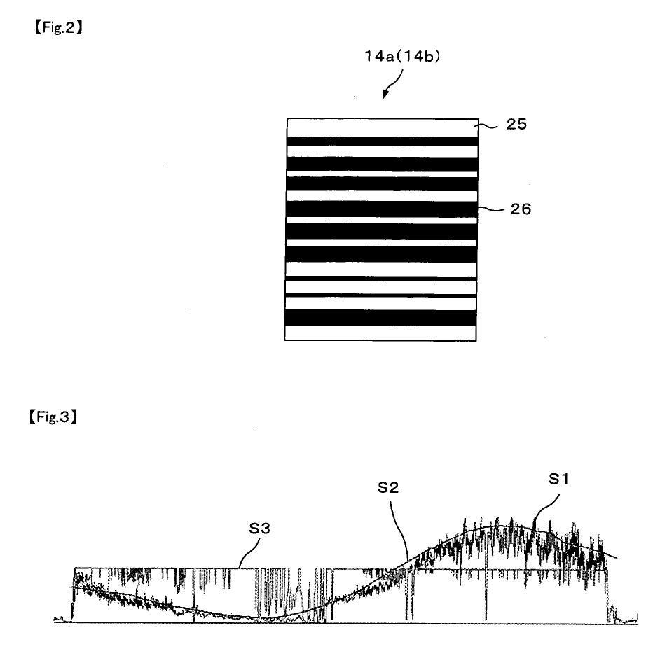

FIG. 2 is a plan view of a reflector 14a or 14b. In the reflector 14a or 14b, a stripe reflection portion (white portion) 25 reflecting an irradiating light beam in a high efficiency and a stripe absorption portion (black portion) 26 absorbing the light beam in a high efficiency are arranged alternately and compose a bar code pattern as shown in FIG. 2. The reference reflection-pattern storage section 19 preliminarily stores the reference reflection pattern of the reflected light obtained by the reflection of this bar code pattern in the reflector 14a or 14b.

Next, an arithmetic method specifying the reflector position in the reflector position specification unit 20 will be described. First, a low-frequency trend component is removed from the reflected light data of the rotating body 13. For removing the trend component, moving average processing is defined in an object range as Formula (1). N is a window width of a moving average and x is a measured waveform value of the reflected light data.

$$\begin{matrix}[ Formula 1 ] & \\ {\overline{x}}_{k} = \frac{1}{N} {\sum }_{j = - \frac{N}{2}}^{\frac{N}{2}} {x}_{k + j} & ( 1 )\end{matrix}$$

Then, a difference of the measured waveform value from a moving-average waveform value is obtained and the difference is divided by the moving-average waveform value as shown in Formula (2). Thereby, Xₖ is obtained as a measured waveform value in which the trend component is removed.

$$\begin{matrix}[ Formula 2 ] & \\ {X}_{k} = \frac{{x}_{k} - {\overline{x}}_{k}}{{\overline{x}}_{k}} & ( 2 )\end{matrix}$$

Here, the measured waveform value within the range of the rotating body 13 is sometimes different in the amplitude depending on a position. For this problem, the measured waveform value Xₖ is normalized, and, for the normalization, a waveform value X′ₖ is defined in a predetermined range j by Formula (3). By this normalization, a constant threshold value can be set for detection of the reflected light data obtained by reflection from the bar code patterns of the reflectors 14a and 14b.

$$\begin{matrix}[ Formula 3 ] & \\ {X}_{j , k}^{′} = \frac{{X}_{j , k}}{Max ( {X}_{j , k} )} & ( 3 )\end{matrix}$$

FIG. 3 is a signal waveform chart normalized from the measured waveform value Xₖ which is obtained from the reflected light data of the reflector 14a or 14b after the trend component is removed. FIG. 3 shows a signal waveform of the reflected light data in the neighborhood of the reflector in the reflected light data of the rotating body 13. The signal waveform S1 shows a measured waveform S1 containing the trend component, the curve S2 shows a moving-average waveform, and the signal waveform S3 shows a signal waveform after the normalization. It is apparent that the signal is emphasized even when the measured waveform S1 has a small amplitude.

In this manner, the signal waveform S3 is extracted from the reflected light data of the reflector 14a or 14b, and is provided with the pattern matching with the reference reflection pattern preliminarily stored in the reference reflection-pattern storage section 19. Then, when the patterns match each other, the waveform signal S3 has the reflection pattern of the reflector 14a or 14b and a starting position and an ending position of the bar code pattern thereof is determined to show the reflector position. In this manner, the reflection of the reflector is extracted from the reflected light data by the pattern matching, and the reflector position is specified. Therefore, it is possible to specify the reflector positions accurately in real time.

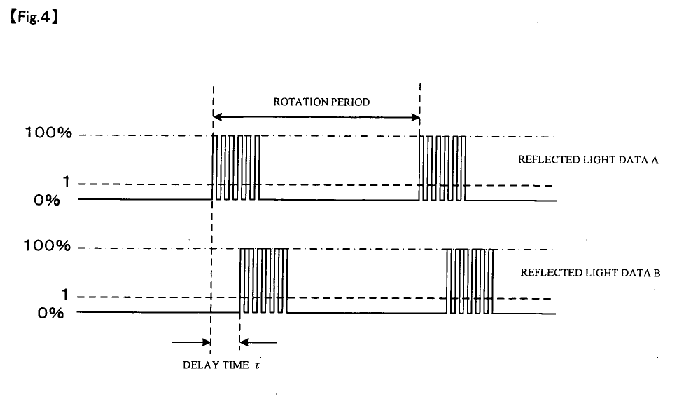

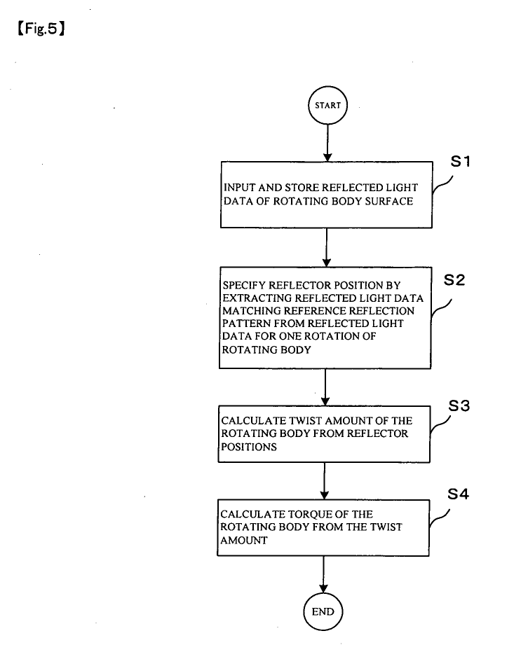

Next, a calculation method of the twist amount of the rotating body 13 in the twist amount calculation unit 21 will be described. The reflected light data at the reflector position specified by the reflector position specification unit 20 shows a reflection pattern where a strong intensity and a weak intensity are repeated periodically for each rotation of the rotating body 13 as shown in FIG. 4. The upper part of FIG. 4 shows the reflected light data A of the reflector 14a, one of the pair of reflectors 14a and 14b, and the lower part thereof shows the reflected light data B of the other reflector 14b. The delay time t of the reflection pattern in the reflected light data B against the reflection pattern in the reflected light data A shows that the twist amount is generated in the rotating body 13.

The twist amount calculation unit 21 first obtains the rotation period of the rotating body 13 from a correlation function of the reflected light data A. Now, a function F(t) is extracted from the reflected light data A, and then the correlation function f(t) of the reflected light data A is expressed by Formula (4). C is a shift time of a detected signal, t is the delay time, and d is a reflection pattern width of the reflected light data A.

$$\begin{matrix}[ Formula 4 ] & \\ Φ i ( τ ) = ( 1 / 2 δ ) {{\sum }_{t = C - δ}}^{t = C + δ} F ( t + τ ) F ( t ) & ( 4 )\end{matrix}$$

The delay time, which maximizes this correlation function f(t), is obtained. This calculation corresponds to an operation of checking overlap between the first detection signal (reflection pattern) and the next detection signal (reflection pattern) by delaying the first detection signal temporally in the reflected light data A, and, when the delay time t becomes close to the rotation period, the first detection signal becomes to coincide with the next detection signal and the value of the correlation function f(t) becomes large. The delay time t at this point becomes the rotation period. This rotation period can be obtained from the reflected light data B as well as the reflected light data A.

Meanwhile, the twist amount of the rotating body 13 is obtained from a correlation function f i(t) between the reflected light data A and the reflected light data B. Now, a function G1(t) is extracted from the output signal of the reflected light data A and a function G2(t) is extracted from the output signal of the second detection signal, and then the correlation function f i(t) is expressed by Formula (5). Ci is a shift time of the detection signal of the reflected light data A, t is a delay time between the reflected light data A and the reflected light data B, and di is a reflection pattern width of the reflected light data A.

$$\begin{matrix}[ Formula 5 ] & \\ Φ i ( τ ) = ( 1 / 2 δ ) {\sum }_{t = Ci - δ i}^{t = Ci + δ i} {G}_{1} ( t ) {G}_{2} ( t + τ ) & ( 5 )\end{matrix}$$

The delay time, which maximizes this correlation function f i(t), is obtained. This calculation corresponds to an operation of checking overlap between the detection signal (reflection pattern) of the reflected light data A and the detection signal (reflection pattern) of the reflected light data B by delaying the detection signal of the reflected light data A. The delay time maximizing the correlation function f i(t) corresponds to the twist amount of a drive axis in the rotating body 13.

While the twist amount of the rotating body 13 is calculated using the correlation function in the above description, the twist amount may be obtained by a method directly obtaining the delay time between the reflected light data A of the reflector 14a and the reflected light data B of the reflector 14b. This is because both of the reflected light data A of the reflector 14a and the reflected light data B of the reflector 14b are the reflected light data at the reflector positions specified by the reflector position specification unit 20 and have the reflection patterns matching the reference reflection patterns of the reflectors, which is preliminarily stored in the reference reflection-pattern storage section 19, and therefore the reflector positions have a high accuracy.

Next, a calculation method for the torque of the rotating body 13 in the torque calculation unit 22 will be described. The torque calculation unit 22 calculates the torque Ft of the rotating body 13 from the twist amount (delay time t) obtained by the twist calculation unit 21. The torque Ft of the rotating body 13 is obtained by Formula (6). K is a torsion spring constant of the drive axis in the rotating body 13, x is a distance between the reflector 14a and the reflector 14b, and T is a rotation period of the rotating body 13.

[Formula 6]

Ft=2pKx·t/T (6)

FIG. 5 is a flowchart of the torque measurement method measuring the torque using the torque measurement device according to the first embodiment of the present invention. First, the reflected light data of the laser light irradiating the surface of the rotating body 13 is input, and the reflected light data is stored for a predetermined number of rotations of the rotating body 13 (S1). Then, the reflector position is specified to be the position having the reflected light data which matches each of the reference reflection patterns of the pair of reflectors 14a and 14b, from the reflected light data of the rotating body 13, the pair of reflectors being provided on the surface of the rotating body 13 and having the spacing in the axial direction (S2). The twist amount of the rotating body 13 is calculated from the specified positions of the pair of reflectors 14a and 14bb (S3), and the torque is calculated from the calculated twist amount of the rotating body (S4).

The first embodiment preliminarily prepares the reference reflection patterns of the reflected light obtained by the reflection of the pair of reflectors 14a and 14b which is provided on the surface of the rotating body 13 having the spacing in the axial direction and specifies the reflector positions by extracting the reflected light pattern matching the reference reflect pattern from the reflected light data which is input according to the rotation of the rotating body 13, in real time using the pattern matching. Thereby, it is possible to detect the position of the pair of reflectors 14a and 14b accurately in real time. Therefore, it becomes possible to measure the torque of the rotating body 13, which is calculated from the positions of the pair of reflectors 14a and 14b, accurately in real time, and the torque of the rotating body 13 can be used for monitor control.

### Second Embodiment

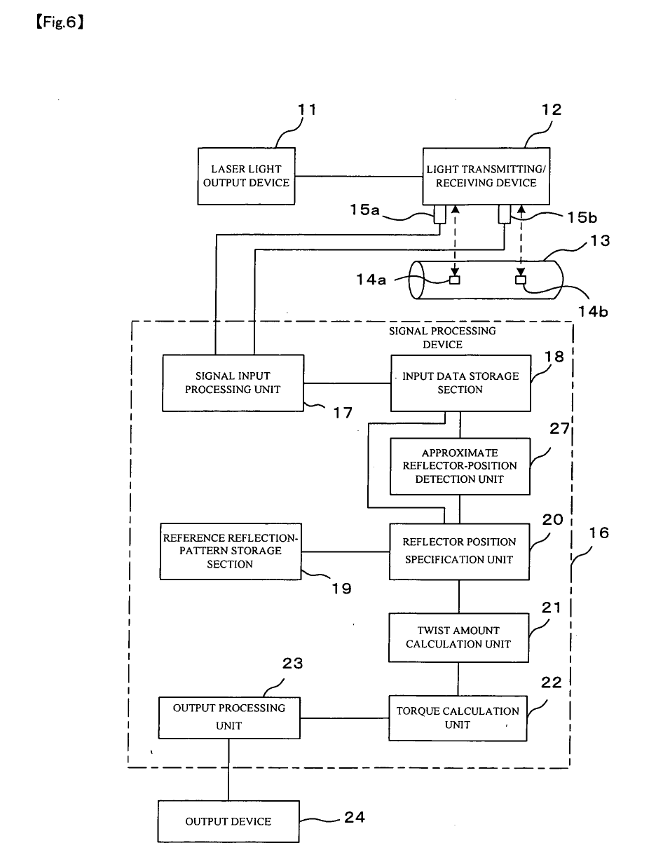

FIG. 6 is a block configuration diagram of a torque measurement device according to a second embodiment of the present invention. This second embodiment provides an approximate reflector-position detection unit 27 added to the first embodiment shown in FIG. 1 for detecting approximate positions of the pair of reflectors 14a and 14b using the reflected light data of the rotating body 13, which is stored in the input data storage section 18, and the reflector position specification unit 20 specifies the position, which has the reflected light data which matches the reference reflection pattern stored in the reference reflection-pattern storage section 19, to be the reflector position from the reflected light data in the neighborhoods of the approximate positions of the pair of reflectors 14a and 14b, which are detected by the approximate reflector-position detection unit 27. The same element as that in FIG. 1 is denoted by the same symbol and repeated explanation will be omitted.

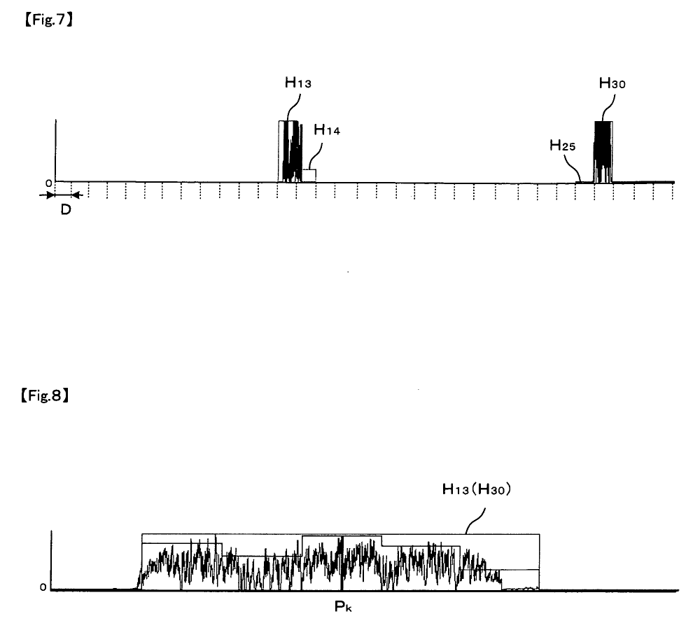

The approximate reflector-position detection unit 27 inputs the reflected light data of the rotating body 13, which is stored in the input data storage section 18, and detects the approximate reflector positions of the pair of reflectors 14a and 14b from the reflected light data of the rotating body 13. The approximate reflector-position detection unit 27 carries out an arithmetic method of detecting the approximate reflector positions as follows. First, the whole measured waveform in the reflected light data of the rotating body 13 is divided into small ranges having a range width D as shown in FIG. 7. Then, an average value Hₖ of an amplitude value xₖ in the measured waveform is calculated for each of the ranges as shown in Formula (7). The divided range width D (D=2 m) is determined to have approximately the same size as a single piece size of the reflectors 14, for example.

$$\begin{matrix}[ Formula 7 ] & \\ {H}_{k} = \frac{1}{2 m} {\sum }_{j = - m}^{j = m} {x}_{k + j} & ( 7 )\end{matrix}$$

The reflected light data in the region of the reflector 14a or 14b shows a larger amplitude value than amplitude values of the peripheral regions thereof, and shows the larger range average value than the average values of the peripheral ranges. Accordingly, a local maximum position of the range average value Hₖ is obtained sequentially, and the local maximum position of the range average value Hₖ, which is larger than a predetermined value, is determined to be the approximated reflector position. For example, in FIG. 7, since the range average values H₁₃ and H₃₀ are larger than the range average values of the peripheral ranges and also larger than the predetermined value, the local maximum positions of the range average values H₁₃ and H₃₀ are determined to be the approximate reflector positions. For the local maximum position of the range average value Hₖ, as shown in FIG. 8, the range is divided further into a plurality of smaller ranges and a position Pₖ, which provides a local maximum of the smaller range average value, is determined to be the approximate position of the reflector 14a or 14b.

The reflector position specification unit 20 inputs the reflected light data in the neighborhoods of the approximate positions of the pair of reflectors 14a and 14b, which are detected by the approximate reflector-position detection unit 27, from the input data storage section 18. The reflected light data in the neighborhood of the reflector 14a or 14b is the reflected light data positioned temporally around the approximate reflector position Pk within a width which is slightly wider than a reflector width. Then, the reflector position specification unit 20 compares the reflected light data in the neighborhood of the approximate reflector position 14a or 14b and the reference reflection pattern stored in the reference reflection pattern-storage section 19 for carrying out the pattern matching, and extracts the matching reflected light data and specifies the reflector positions in real time.

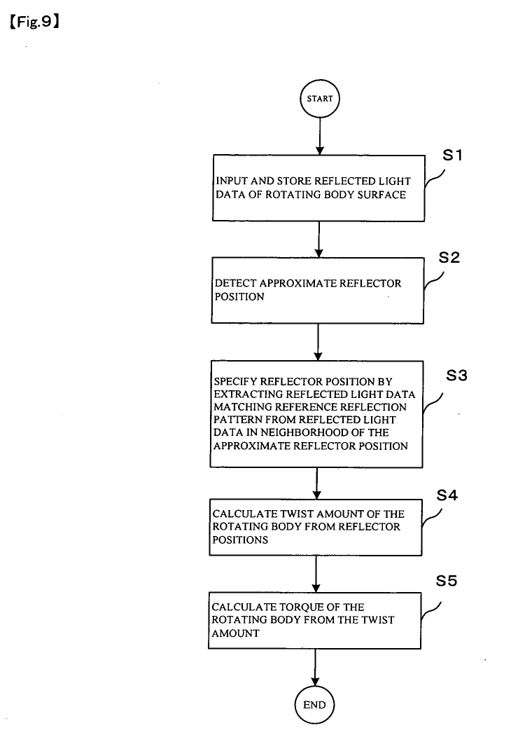

FIG. 9 is a flowchart showing the torque measurement method measuring the torque using the torque measurement device according to the second embodiment of the present invention. First, the reflected light data of the laser light irradiating the surface of the rotating body 13 is input, and the reflected light data is stored for a predetermined number of rotations of the rotating body 13 (S1). Then, the approximate positions are detected for the pair of reflectors 14a and 14b, which is provided on the surface of the rotating body 13 having the spacing in the axial direction, from the reflected light data of the rotating body 13 (S2), and the position having the reflected light data, which matches each of the reference reflection patterns of the pair of reflectors 14a and 14b, is specified to be the reflector position from the reflected light data in the neighborhood of the approximate reflector position (S3). The twist amount of the rotating body 13 is calculated from the specified positions of the pair of reflectors 14a and 14b (S4). The torque is calculated from the calculated twist amount of the rotating body (S5).

According to the second embodiment, the reflector position specification unit 20 carries out the pattern matching only for the reflected light data in the neighborhoods of the approximate positions of the reflectors 14a and 14b, and thereby does not need to carry out the pattern matching for the whole reflected light data as in the first embodiment. Therefore, the second embodiment has an advantage of further reducing the detection processing of the reflector positions in addition to the advantage of the first embodiment.

### Third Embodiment

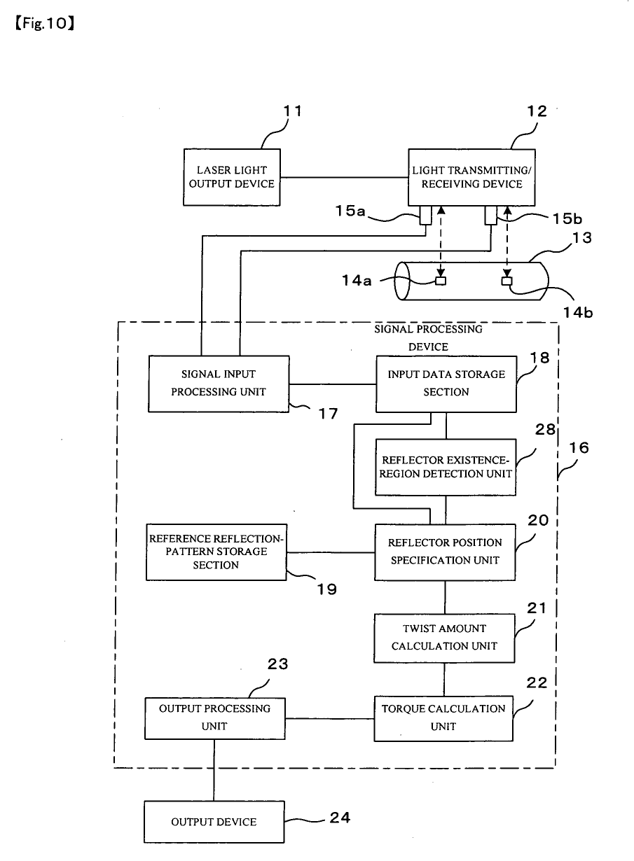

FIG. 10 is a block configuration diagram of a torque measurement device according to a third embodiment of the present invention. This third embodiment provides a reflector existence-region detection unit 28 added to the first embodiment shown in FIG. 1 for detecting existence regions of the pair of reflectors 14a and 14b using the reflected light data of the rotating body 13, which is stored in the input data storage section 18, and the reflector position specification unit 20 specifies the position, which has the reflected light data which matches the reference reflection pattern stored in the reference reflection-pattern storage section 19, to be the reflector position from the reflected light data in the existence regions of the pair of reflectors 14a and 14b, which are detected by the reflector existence-region detection unit 28. The same element as that in FIG. 1 is denoted by the same symbol and repeated explanation will be omitted.

The reflector existence-region detection unit 28 inputs the reflected light data of the rotating body 13, which is stored in the input data storage section 18, and detects the existence regions of the pair of reflectors 14a and 14b. The reflector existence-region detection unit 28 detects the reflector existence-regions by the arithmetic method as follows.

Waveform data of the measured reflected light data has a different characteristic between the waveform data of the region having the reflection pattern of the reflector 14a or 14b and the waveform data in the region having no reflection pattern.

Accordingly, there are assumed two waveform data models for the reflected light data stored in the input data storage section 18; a waveform data model M1 which does not have the reflected light pattern of the reflector 14a or 14b and a waveform data model M2 in the region where the reflection pattern exists. Then, AIC (Akaike's Information Criterion) is obtained for a reflected light data model M including the model M1 and the model M2, and a point which minimizes AIC of the reflected light data model M is determined for detecting the existence regions of the pair of reflectors 14a and 14b. That is, a starting position and an ending position for each of the reflectors 14a and 14b are detected, and the existence regions of the pair of reflectors 14a and 14b are detected.

Here, AIC is expressed by the following formula (8). L is a maximum likelihood and log (L) is a maximum logarithm likelihood.

[Formula 8]

AIC=−2×log(L)+2×(Number of parameters) (8)

Now, both of the waveform data model M1 for the region without the reflector pattern and the waveform data model M2 for the region with the reflector pattern utilize the range average values for the models. Then, the range average value of the model M1 is nearly zero, and the range average value of the model M1 is a value corresponding to a reflected light level of the reflection pattern. Therefore, focusing on the reflected light data model M including the model M1 and the model M2, a point for the best fitting of the reflected light data model M is a boundary point between the model M1 and the model M2. That is, the point of minimizing AIC is determined for the reflected light data model M and the starting point and the ending point for each of the pair of reflectors 14a and 14b are detected, and then the existence regions of the pair of reflectors 14a and 14b are detected.

From the above, the reflected light data model M is divided into two models Ma and Mb hypothetically, and the maximum likelihood La of the model Ma is assumed to be expressed by Formula (9-1) and the maximum likelihood Lb of the model Mb is assumed to be expressed by Formula (9-2).

$$\begin{matrix}[ Formula 9 ] & \\ {L}_{a} = {( \frac{1}{\sqrt{2 π}} )}^{N} {( {σ}_{a}^{2} )}^{- \frac{N}{2}} {e}^{- \frac{N}{2}} & ( 9 \text{-} 1 ) \\ {L}_{b} = {( \frac{1}{\sqrt{2 π}} )}^{N} {( {σ}_{b}^{2} )}^{- \frac{N}{2}} {e}^{- \frac{N}{2}} & ( 9 \text{-} 2 )\end{matrix}$$

N is the number of object ranges, e is a base of a logarithm, dₐ² is a dispersion of the waveform data in the region without the reflection pattern, d_{b}² is a dispersion of the waveform data in the region with the reflection pattern, and the dispersion dₐ² is expressed by Formula (10-1) and the dispersion d_{b}² is expressed by Formula (10-2).

$$\begin{matrix}[ Formula 10 ] & \\ {σ}_{a}^{2} ( p ) = \frac{1}{p} {\sum }_{j = 0}^{p} {( {x}_{j} - {\overline{x}}_{a} )}^{2} & ( 10 \text{-} 1 )\end{matrix}$$

p is a parameter, and x̅ₐ is a range average value.

$${σ}_{b}^{2} ( p ) = \frac{1}{N - p - 1} {\sum }_{j = p + 1}^{N} {( {x}_{j} - {\overline{x}}_{b} )}^{2} \qquad ( 10 \text{-} 2 )$$

p is a parameter, x̅_{b} is a range average value, and N is the number of data sets.

Next, Formula (9-1) is substituted into Formula (8), and Formula (11-1) is obtained for calculating AICa of the model Ma. In this case, the parameter is only p and the number of parameters becomes 1. Similarly, Formula (9-2) is substituted into Formula (8) and 1 is substituted for the number of parameters, and then Formula (11-2) is obtained for calculating AICb of the model Mb.

[Formula 11]

AICₐ={(p+1)(log(2πσₐ²)+1)+2} (11-1)

AIC_{b}={(N−p)(log(2πσ_{b}²)+1)+2} (11-2)

Then, AICp for the reflected light data model M is obtained as a sum of AICa and AICb as shown in Formula (12).

$$\begin{matrix}[ Formula 12 ] & \\ \begin{matrix}{AIC}_{p} = {AIC}_{a} + {AIC}_{b} \\ = \{ ( p + 1 ) ( log ( 2 π {σ}_{a}^{2} ) + 1 ) + 2 \} + \\ \{ ( N - p ) ( log ( 2 π {σ}_{b}^{2} ) + 1 ) + 2 \}\end{matrix} & ( 12 )\end{matrix}$$

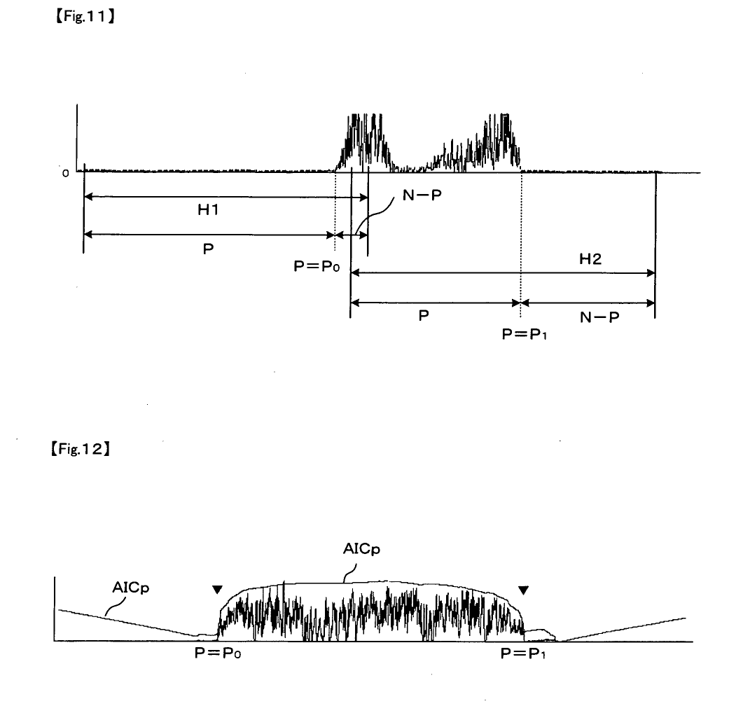

FIG. 11 is an explanatory diagram of a calculation range of AICp. For example, an AICp value expressed by Formula (12) is obtained by changing the parameter p for the number of data sets N in the object range H1 of the reflected light data. When the object range H1 includes the starting position (p=p₀) of the reflection pattern of the reflector, the AICp value becomes smaller gradually and increases abruptly from a minimum value, as the parameter p increases, as shown in FIG. 12. The position of this minimum value (p=p₀) is the starting position of the reflector.

On the other hand, when the object range H2 includes the ending position (p=p₀₁) of the reflection pattern of the reflector as shown in FIG. 11, the AICp value becomes smaller gradually and reduces abruptly to be a minimum value, and then becomes larger gradually, as the parameter p increases, as shown in FIG. 12. The position of this minimum value (p=p₁) is the ending position of the reflector.

In this manner, for detecting the existence positions of the reflectors 14a and 14b, the reflector existence-region detection unit 28 changes the AICp parameter p for the reflected light data in the object range as shown in FIG. 11 and detects the point for the best fitting of the reflected light data model M to be a boundary point between the region with the reflector pattern and the region without the reflector pattern, as shown in FIG. 12. Accordingly, the position of the reflector 14a or 14b is detected as the starting position and the ending position, and thereby it is possible to detect the reflector positions more accurately than the approximate reflector positions in the second embodiment.

The reflector position specification 20 inputs the reflected light data in the existence regions of the pair of reflectors 14a and 14b, which are detected by the reflector existence-region detection unit 28, from the input data storage section 18. The reflected light data in the existence region of the reflector 14a or 14b is the reflected light data positioned temporally within a width slightly wider than a width from the starting position to the ending position of the reflector. Then, the reflector position specification unit 20 compares the reflected light data in the existence region of the reflector 14a or 14b and the reference reflection pattern stored in the reference reflection-pattern storage section 19, for the pattern matching, and extracts the matching reflected light data and specifies the reflector positions in real time.

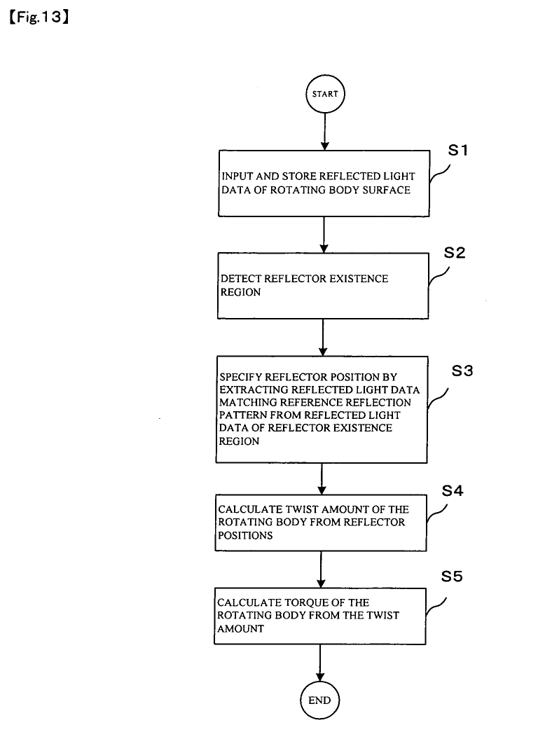

FIG. 13 is a flowchart showing the torque measurement method measuring the torque using the torque measurement device according to the third embodiment of the present invention. First, the reflected light data of the laser light irradiating the surface of the rotating body 13 is input, and the reflected light data is stored for a predetermined number of rotations of the rotating body 13 (S1). Then, the existence regions of the pair of reflectors 14a and 14b, which is provided on the surface of the rotating body 13 having the spacing in the axial direction, are detected from the reflected light data of the rotating body 13 (S2), and the position having the reflected light data, which matches each of the reference reflection patterns of the pair of reflectors 14a and 14b, is specified to be the reflector position from the reflected light data of the existence region (S3). The twist amount of the rotating body 13 is calculated from the specified positions of the pair of reflectors 14a and 14b (S4), and the torque is calculated from the calculated twist amount of the rotating body (S5).

According to the third embodiment, the reflector position specification unit 20 carries out the pattern matching only for the reflected light data of the existence regions of the reflectors 14a and 14b, and thereby does not need to carry out the pattern matching for the whole reflected light data as in the first embodiment. Further, the reflector existence regions can be more accurately detected than the approximate reflector positions in the second embodiment, and thereby a data amount is reduced for the reflected light data, to which the pattern matching is provided by the reflector position specification unit 20. Therefore, the third embodiment has an advantage of further reducing the detection processing of the reflector positions in addition to the advantage of the first embodiment and the advantage of the second embodiment.

### Fourth Embodiment

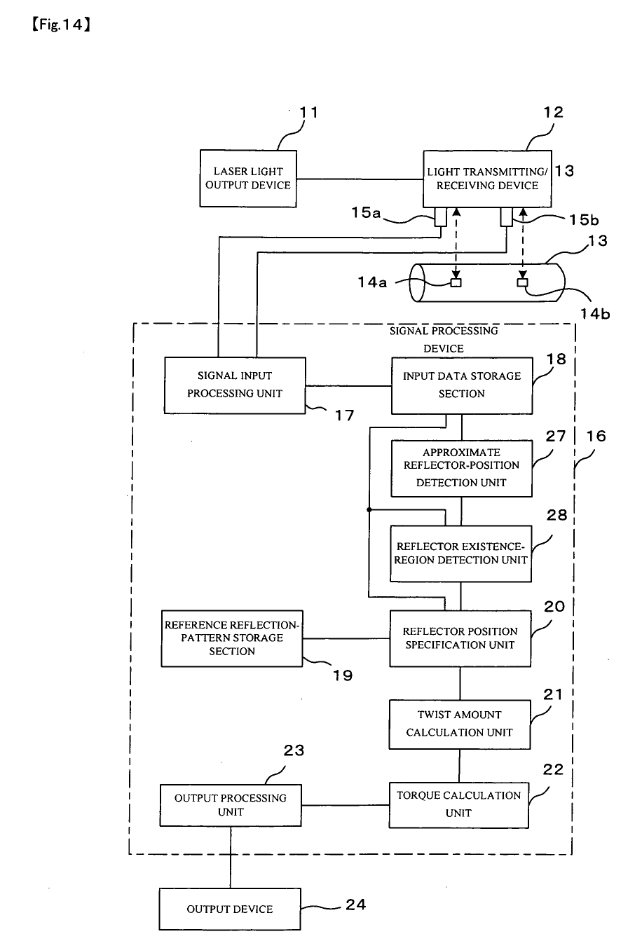

FIG. 14 is a block configuration diagram of a torque measurement device according to a fourth embodiment of the present invention. This fourth embodiment provides an approximate reflector-position detection unit 27 added to the third embodiment shown in FIG. 10 for detecting approximate positions of the pair of reflectors 14a and 14b using the reflected light data of the rotating body 13, which is stored in the input data storage section 18, wherein the reflector existence-region detection unit 28 detects the existence regions of the pair of reflectors 14a and 14b from the reflected light data in the neighborhoods of the approximate positions of the pair of reflectors 14a and 14b, which are detected by the approximate reflector-position detection unit 27, and the reflector position specification unit 20 specifies the position, which has the reflected light data which matches the reference reflection pattern stored in the reference reflection-pattern storage section 19, to be the reflector position from the reflected light data of the existence regions of the pair of reflectors 14a and 14b, which are detected by the reflector existence-region detection unit 28. The same element as that in FIG. 10 is denoted by the same symbol and repeated explanation will be omitted.

The approximate reflector-position detection unit 27 inputs the reflected light data of the rotating body 13, which is stored in the input data storage section 18, and detects the approximate reflector-positions of the pair of reflectors 14a and 14b from the reflected light data of the rotating body 13. The approximate reflector-position detection unit 27 detects the approximate reflector positions by the arithmetic method described in the second embodiment: the whole measured waveform of the reflected light data of the rotating body 13 is divided into small ranges, a local maximum position of the range average value Hₖ in the divided small range is obtained sequentially, and the local maximum position of the range average value Hₖ, which is larger than a predetermined value, is determined to be the approximate reflector position.

The reflector existence-region detection unit 28 inputs the reflected light data in the neighborhoods of the approximate reflector positions of the pair of reflectors 14a and 14b, which are detected by the approximate reflector-position detection unit 27, from the input data storage section 18, and detects the existence regions of the pair of reflectors 14a and 14b from the reflected light data in the neighborhoods of the approximate positions of the pair of reflectors 14a and 14b, by the arithmetic method described in the third embodiment.

The reflector position specification unit 20 inputs the reflected light data of the existence regions of the pair of reflectors 14a and 14b, which are detected by the reflector existence-region detection unit 28, from the input data storage section 18, and compares the reflected light data of the existence regions of the pair of reflectors 14a and 14b and the reference reflection pattern stored in the reference reflection-pattern storage section 19 for the pattern matching, and then, extracts the matching reflected light data and specifies the reflector positions in real time.

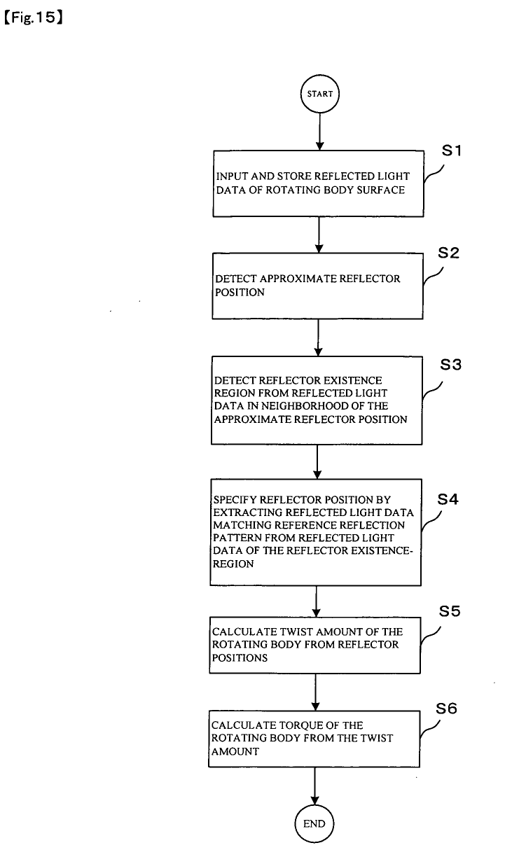

FIG. 15 is a flowchart showing the torque measurement method measuring the torque using the torque measurement device according to the fourth embodiment of the present invention. First, the reflected light data of the laser light irradiating the surface of the rotating body 13 is input, and the reflected light data is stored for a predetermined number of rotations of the rotating body 13 (S1). Then, the approximate reflector positions of the pair of reflectors 14a and 14b, which is provided on the surface of the rotating body 13 having the spacing in the axial direction, are detected (S2), the existence regions of the pair of reflectors 14a and 14b are detected from the reflected light data in the neighborhoods of the approximate reflector positions (S3), and the position having the reflected light data, which matches each of the reference reflection patterns of the pair of reflectors 14a and 14b, is specified to be the reflector position from the reflected light data of the existence region (S4). The twist amount of the rotating body 13 is calculated from the specified positions of the pair of reflectors 14a and 14b (S5), and the torque is calculated from the calculated twist amount of the rotating body (S6).

According to the fourth embodiment, the detection processing of the existence regions of the pair of reflectors 14a and 14b is carried out only for the reflected light data in the neighborhoods of the approximate positions of the pair of reflectors 14a and 14b, and further the pattern matching is carried out only for the reflected light data of the existence regions of the reflectors 14a and 14b. Thereby, the fourth embodiment has an advantage of detecting the reflector existence regions more quickly and more accurately, in addition to the advantage of the third embodiment.

Here, the method described in each of the foregoing embodiments can be applied to each device as a computer-executable program stored in a storage medium, or can be applied to each device as a computer-executable program transmitted via a communication medium.

The storage media for the present invention include such as a magnetic disk, a flexible disk, an optical disk (CD-ROM, CD-R, DVD, etc.) a magneto-optical disk (MO and the like), a semiconductor memory, etc., and storage format thereof may be any type as far as the storage medium is a program-storable and computer-readable storage medium. Further, the storage media here are not limited to the media independent from a computer and include a storage medium storing or temporarily storing a program which is transmitted and downloaded via a LAN or the Internet.

1. A torque measurement device provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof and reflects the irradiating laser light from the light transmitting/receiving device in a predetermined reflection pattern; and a signal processing device obtaining a torque of the rotating body from the reflected light received by the light transmitting/receiving device, the signal processing device comprising:
a reference reflection-pattern storage section preliminarily storing a reference reflection pattern of the reflected light obtained by reflection from the pair of reflectors;
an input data storage section storing reflected light data of the laser light irradiating the surface of the rotating body, the reflected light data being input according to rotation of the rotating body;
a reflector position specification unit specifying a position having the reflected light data, which matches the reference reflection pattern stored in the reference reflection pattern storage section, to be a reflector position from the reflection light data of the rotating body stored in the input data storage section;
a twist amount calculation unit calculating a twist amount of the rotating body from the reflector positions which are specified by the reflector position specification unit; and
a torque calculation unit calculating a torque from a twist amount of the rotating body, the twist amount being calculated by the twist amount calculation unit.

2. A torque measurement device provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof and reflects the irradiating laser light from the light transmitting/receiving device in a predetermined reflection pattern; and a signal processing device obtaining a torque of the rotating body from the reflected light received by the light transmitting/receiving device, the signal processing device comprising:
a reference reflection-pattern storage section preliminarily storing a reference reflection pattern of the reflected light obtained by reflection from the pair of reflectors;
an input data storage section storing reflected light data of the laser light irradiating the surface of the rotating body, the reflected light data being input according to rotation of the rotating body;
an approximate reflector-position detection unit detecting approximate positions of the pair of reflectors from the reflected light data of the rotating body, the reflected light data being stored in the input data storage section;
a reflector position specification unit specifying a position having the reflected light data, which matches the reference reflection pattern stored in the reference reflection-pattern storage section, to be a reflector position from the reflection light data in neighborhoods of the approximate positions of the pair of reflectors, the reflected light data being detected by the approximate reflector-position detection unit;
a twist amount calculation unit calculating a twist amount of the rotating body from the reflector positions which are specified by the reflector position specification unit; and
a torque calculation unit calculating a torque from a twist amount of the rotating body, the twist amount being calculated by the twist amount calculation unit.

3. A torque measurement device provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof and reflects the irradiating laser light from the light transmitting/receiving device in a predetermined reflection pattern; and a signal processing device obtaining a torque of the rotating body from the reflected light received by the light transmitting/receiving device, the signal processing device comprising:
a reference reflection-pattern storage section preliminarily storing a reference reflection pattern of the reflected light obtained by reflection from the pair of reflectors;
an input data storage section storing reflected light data of the laser light irradiating the surface of the rotating body, the reflected light data being input according to rotation of the rotating body;
a reflector existence-region detection unit detecting existence regions of the pair of reflectors by determining a point which minimizes AIC of a model for the reflected light data of the rotating body, the reflected light data being stored in the input data storage section;
a reflector position specification unit specifying a position having the reflected light data, which matches the reference reflection pattern stored in the reference reflection-pattern storage section, to be a reflector position from the reflected light data of the existence regions of the pair of reflectors, the existence regions being detected by the reflector existence-region detection unit;
a twist amount calculation unit calculating a twist amount of the rotating body from the reflector positions which are specified by the reflector position specification unit; and
a torque calculation unit calculating a torque from a twist amount of the rotating body, the twist amount being calculated by the twist amount calculation unit.

4. A torque measurement device provided with: a laser light output device outputting laser light; a light transmitting/receiving device irradiating a surface of a rotating body with the laser light from the laser light output device and also receiving reflected light thereof; a pair of reflectors which is provided on the surface of the rotating body, having a spacing in an axial direction thereof and reflects the irradiating laser light from the light transmitting/receiving device in a predetermined reflection pattern; and a signal processing device obtaining a torque of the rotating body from the reflected light received by the light transmitting/receiving device, the signal processing device comprising:
a reference reflection-pattern storage section preliminarily storing a reference reflection pattern of the reflected light obtained by reflection from the pair of reflectors;
an input data storage section storing reflected light data of the laser light irradiating the surface of the rotating body, the reflected light data being input according to rotation of the rotating body;
an approximate reflector-position detection unit detecting approximate positions of the pair of reflectors from the reflected light data of the rotating body, the reflected light data being stored in the input data storage section;
a reflector existence-region detection unit detecting existence regions of the pair of reflectors by determining a point which minimizes AIC of a model for the reflected light data in neighborhoods of the approximate reflector positions of the pair of reflectors, the approximate reflector positions being detected by the approximate reflector-position detection unit;
a reflector position specification unit specifying a position having the reflected light data, which matches the reference reflection pattern stored in the reference reflection-pattern storage section, to be a reflector position from the reflected light data of the existence regions of the pair of reflectors, the existence regions being detected by the reflector existence-region detection unit;
a twist amount calculation unit calculating a twist amount of the rotating body from the reflector positions which are specified by the reflector position specification unit; and
a torque calculation unit calculating a torque from a twist amount of the rotating body, the twist amount being calculated by the twist amount calculation unit.

5. A program enabling a computer to carry out a method, comprising the steps of:
storing reflected light data of laser light irradiating a surface of a rotating body, the reflected light data being input according to rotation of the rotating body;
specifying a position having the reflected light data, which matches one of reference reflection patterns of a pair of reflectors, to be a reflector position from the reflected light data of the rotating body, the pair of reflectors being provided on the surface of the rotating body and having a spacing in an axial direction thereof;
calculating a twist amount of the rotating body from the specified positions of the pair of reflectors; and
calculating a torque from the calculated twist amount of the rotating body.

6. A program enabling a computer to carry out a method, comprising the steps of:
storing reflected light data of laser light irradiating a surface of a rotating body, the reflected light data being input according to rotation of the rotating body;
detecting approximate positions of the pair of reflectors from the reflected light data of the rotating body;
specifying a position having the reflected light data, which matches each of reference reflection patterns of the pair of reflectors, to be a reflector position from the reflected light data in neighborhoods of the detected approximate positions of the pair of reflectors, the pair of reflectors being provided on the surface of the rotating body and having a spacing in an axial direction thereof;
calculating a twist amount of the rotating body from the specified reflector positions; and
calculating a torque from the calculated twist amount of the rotating body.

7. A program enabling a computer to carry out a method, comprising the steps of:
storing reflected light data of laser light irradiating a surface of a rotating body, the reflected light data being input according to rotation of the rotating body;
detecting existence regions of the pair of reflectors by determining a point which minimizes AIC of a model for the reflected light data of the rotating body;
specifying a position having the reflected light data, which matches one of reference reflection patterns of the pair of reflectors, to be a reflector position from the reflected light data of the detected existence regions of the pair of reflectors, the pair of reflectors being provided on the surface of the rotating body and having a spacing in an axial direction thereof;
calculating a twist amount of the rotating body from the specified reflector positions; and
calculating a torque from the calculated twist amount of the rotating body.

8. A program enabling a computer to carry out a method, comprising the steps of:
storing reflected light data of laser light irradiating a surface of a rotating body, the reflected light data being input according to rotation of the rotating body;
detecting approximate positions of the pair of reflectors from the reflected light data of the rotating body;
detecting existence regions of the pair of reflectors by determining a point which minimizes AIC of a model for the reflected light data in neighborhoods of the detected approximate positions of the pair of reflectors;
specifying a position having the reflected light data, which matches one of reference reflection patterns of the pair of reflectors, to be a reflector position from the reflected light data of the detected existence regions of the pair of reflectors, the pair of reflectors being provided on the surface of the rotating body and having a spacing in an axial direction thereof;
calculating a twist amount of the rotating body from the specified reflector positions; and
calculating a torque from the calculated twist amount of the rotating body.
